(19) United States
(12) Patent Application Publication
(10) Pub. No.: US 2011/0121668 A1
(43) Pub. Date: May 26, 2011

(54) PERMANENT MAGNET ROTOR, AND ROTATING MACHINE COMPRISING SUCH A ROTOR

(75) Inventors: Dominique Condamin, Angouleme (FR); Michel Labonne, Angouleme (FR); Patrick Camus, Saint Yrieix (FR); Stephane Dufau, Angouleme (FR)

(73) Assignee: MOTEURS LEROY-SOMER, ANGOULEME (FR)

(21) Appl. No.: 12/997,123

(22) PCT Filed: Jun. 15, 2009
(86) PCT No.: PCT/FR09/51132

§ 371 Date: Feb. 7, 2011

(30) Foreign Application Priority Data
Jun. 16, 2008 (FR) 08 53968

(51) Int. Cl. H02K 1/27; H02K 15/16

(52) U.S. Cl. 310/51; 310/156.43

(57) ABSTRACT

A rotor for rotating an electric machine having permanent magnets and flux concentration, including a shaft extending along the rotational axis of the rotor, a rotor body placed on the shaft, the rotor body having a central opening for the mounting thereof on the shaft; radially oriented recesses wherein the permanent magnets are placed; and in at least one angular space separating two consecutive recesses, at least one cavity leading neither to the central opening nor to the two consecutive recesses, the cavity or cavities located in the space occupying an angular area around the rotational axis of the rotor greater than or equal to half of the angular area of the space.

The present invention relates to electric rotary machines, in particular synchronous motors, and more particularly it relates to a machine having a rotor with permanent magnets and flux concentration.

Rotors with flux concentration comprise a rotor mass having magnets housed therein, the magnets being engaged in housings that are radially oriented.

An advantage of such rotors is the possibility of obtaining mean inductions in the airgap greater than the working induction of the magnets, thus making it possible to reduce the cost of the machine by using magnets based on ferrite, or else making it possible to make the machine more compact when using magnets based on rare earths.

Magnetic flux losses must be reduced in the rotor, and the magnetic flux of the permanent magnets must loop through the stator and not through the rotor or the rotor shaft.

For this purpose, several solutions are known, each suffering from drawbacks.

The magnetic poles situated at opposite ends of the magnets may be totally separated magnetically, as described in EP 1 152 516 E1. It is then necessary to have a non-magnetic hub around the rotor shaft, or a shaft that is itself non-magnetic. Such a configuration complicates installing the magnetic poles, and the use of non-magnetic steel or aluminum for making the hub or the shaft is relatively expensive.

U.S. Pat. No. 5,684,352 teaches connecting the bottom and top ends of the magnetic poles together via regions that have been subjected to treatment that makes the laminations locally non-magnetic. That solution involves implementing relatively expensive heat treatment.

There also exist solutions consisting in making one or more cavities in the rotor in order to limit magnetic flux losses.

U.S. patent application No. 2007/0252469 thus describes a rotor lamination having cavities extending on either side of housings that receive the permanent magnets, the cavities opening out into the housings and leaving between them bridges of material of narrow width. Such a solution presents the drawback of concentrating mechanical forces in the middles of the magnetic poles, which can be harmful to the mechanical strength of the rotor at high speeds of rotations.

U.S. Pat. No. 6,133,663 also describes a rotor lamination having cavities for reducing magnetic flux losses, each cavity opening out into two consecutive housings that receive permanent magnets, at the radially inner ends of the housings.

Patent application FR 2 283 572 discloses a rotor lamination that presents cavities opening out into the central opening that enables it to be mounted on the shaft.

Patent application JP 2000-209798 describes a rotor lamination having a plurality of circularly arcuate slots between permanent magnets. Slots oriented perpendicularly to the middle axes between the magnets limit magnetic flux looping towards the inside. The orientation of those slots may affect the mechanical properties of the rotor at high speeds of rotation, since the width of the lamination around the passage for the shaft is relatively small. Those slots extend to the interval between the magnets and the passage for the shaft. Such angular overlaps between the housings for the magnets and the slots makes it necessary for the magnets to be spaced apart from the passage for the shaft, and that can limit the power of magnets suitable for use in a given size of rotor.

U.S. patent application No. 2006/0290222 describes a rotor lamination having housings for permanent magnets, the lamination not having cavities between the housings.

There exists a need to further improve flux-concentrating rotors, and in particular to reduce their fabrication costs while benefiting from satisfactory electrical and mechanical performance.

The present invention seeks to satisfy this need and to remedy the above-mentioned drawbacks in full or in part.

Thus, in one of its aspects, the present invention provides a rotor having permanent magnets and flux concentration, the rotor comprising:
a shaft extending along the axis of rotation of the rotor;
a rotor mass disposed on the shaft, and comprising:
   a central opening for mounting on the shaft; and
   radially-oriented housings in which the permanent magnets are placed; and
at least one cavity in at least one, and preferably in each, angular interval between two consecutive housings, the cavity(ies) opening out neither to the central opening nor to the two consecutive housings, said cavity(ies) situated in said interval occupying an angular extent around the axis of rotation of the rotor that is greater than or equal to half the angular extent of said interval.

Radially oriented housings may have a long axis that optionally coincides with a radius. The long axis may be parallel to a radius.

Such housings cover housings in which the greatest radial dimension of the housing is greater than the greatest circumferential dimension of the housing (measured between two points at the same distance from the center, along a segment passing via said points and perpendicular to a bisecting radius).

The cavity(ies) create zones between the permanent magnets in which magnetic flux cannot pass easily towards the shaft, thereby limiting magnetic flux looping towards the radially inner portion of the rotor. In particular, the portion of the lamination situated between a magnet housing and the adjacent cavity presents magnetic flux saturation, thereby limiting the amount of flux that passes therethrough.

The greatest radial dimension of the cavity(ies) may be greater than its/their greatest circumferential dimension.

The radial dimension of the annular portion of lamination between the cavity(ies) and the central opening may be less than or equal to the radial dimension of the annular portion of lamination between the cavities of the outer periphery of the rotor mass.

Each housing, and the cavities adjacent to the housing, may advantageously be angularly offset without any angular overlap.

Furthermore, the invention may make it possible to create a large number of bridges of material between the housings and the cavities in order to distribute the centrifugal forces over the radially inner portion of the rotor mass.

By way of example, the number of these bridges of material may be equal to twice the number of permanent magnets.

By way of example, the rotor mass is formed by assembling rotor laminations, by machining a block of magnetic material, or by casting a polymer material filled with magnetic particles.

The rotor mass is advantageously formed by assembling rotor laminations, each lamination being in one piece. Thus, the rotor does not have any pole pieces fitted thereto.

The invention may make it possible to avoid having recourse to non-magnetic parts such as a non-magnetic shaft or hub, such parts being relatively expensive. The rotor shaft may thus be made of a magnetic material, e.g. C35E steel, instead of being made of aluminum.

Each rotor lamination may for example be cut from a sheet of magnetic steel, e.g. steel that is 0.1 millimeters (mm) to 1.5 mm thick, e.g. M400-50A. The laminations may be coated in an electrically insulating varnish on their opposite faces prior to being assembled within the stack. Insulation may also be obtained by heat treating the laminations.

The distribution of the cavities and/or of the housings is advantageously regular and symmetrical, thereby making it easier to cut out the rotor lamination and making it easier to ensure it is stable after being cut out, when the rotor mass is constituted by a stack of rotor laminations.

The cavity(ies) situated in each interval between two consecutive housings may occupy three-fourths or more than three-fourths of the angular extent of the interval.

The width of a bridge between two adjacent cavities or between a cavity and an adjacent housing may lie, for example, in the range 0.5 mm to 3 mm in an embodiment of the invention. By way of example, two consecutive housings may be angularly separated by an angle of 45°.

The housings and the cavities are separated from the central opening of the rotor mass by an annular portion that may have a minimum radial dimension lying in the range 2 mm to 5 mm, e.g. being about 3 mm for a rotor lamination having a diameter of 140 mm, but they could equally well be much thicker or much thinner depending on the diameter of the rotor. Such an annular portion of cylindrical shape contributes to the strength of the rotor.

The number of housings and magnets depends on the polarity of the rotor. The rotor mass may have an arbitrary number of pairs of housings, e.g. six or eight housings. The number of cavities may be greater than or equal to half the number of housings.

The cavities are advantageously of radial dimension that is less than or equal to the radial dimension of the housings, so as to avoid successively reducing the flux concentration of the magnets.

The radial dimension of the cavities may for example be about half the radial dimension of the housings.

The housings may have a radial dimension greater than or equal to the radial dimension of the permanent magnets received inside said housings. This allows larger manufacturing tolerances for the rotor mass and for the magnets, and can enable the magnets to be wedged in the housings by centrifuging.

The housings may optionally open out radially to the outside.

The rotor mass may comprise one single cavity for two intervals, or one single cavity for each interval, between two consecutive housings, or in a variant a plurality of cavities, e.g. two cavities, which cavities are preferably identical and symmetrical to each other about a midplane.

The cavities are advantageously oriented radially. Radially oriented cavities may have a long axis that optionally coincides with a radius or that is parallel to a radius.

The bridges between these cavities or between the cavities and the housings are advantageously oriented radially.

Each cavity may comprise two branches beside the shaft, which branches unite going towards the stator. The two branches may be separated by an edge portion that is concave towards the shaft.

The two branches may have a radially inner edge that is oriented circumferentially.

Each cavity may have edges that converge towards each other from a zone situated at a distance from the axis of rotation that corresponds substantially to the zone of the radially inner ends of the magnets. These edges may converge via circular arcs and they may be extended by edges that are substantially parallel.

The width of the bridge of material between a housing and the adjacent cavity may lie for example in the range 0.5 mm to 2.5 mm, e.g. being about 1.5 mm.

In addition to the cavities, the rotor mass may also comprise one or more holes for lightening the rotor, for enabling it to be balanced, or for assembling together the rotor laminations making it up.

Each permanent magnet may present a cross-section that is optionally rectangular in shape. For example, each permanent magnet may present a cross-section that is trapezoidal or lozenge-shaped.

The cavities and/or housings may be filled at least in part, or completely, with non-magnetic synthetic material. The material may serve to hold the magnets in place in the housings and/or to increase the cohesion of the stack of laminations.

Where appropriate, the cavities may be used for balancing the rotor, by removing material locally, e.g. by removing a synthetic material such as a resin present in the cavities. It is also possible to fill the cavities to a greater or lesser extent with resin in order to balance the rotor, or to provide holes in the resin that can subsequently be filled to a greater or lesser extent in order to balance the rotor.

Where appropriate, the rotor mass may comprise one or more portions in relief contributing to properly positioning the magnets. The housings may receive wedges for positioning the magnets in the housings.

Each rotor mass may present an outer outline that is circular or that is multi-lobed, where a multi-lobed shape may be useful, e.g. for the purpose of reducing torque ripple or current or voltage harmonics.

Each housing may present a radially inner portion relative to the corresponding permanent magnet, which portion is laterally defined by opposite edges that are substantially radial. Each housing may present a radially outer portion relative to the corresponding permanent magnet having edges that converge towards each other going away from the shaft. These radially inner and outer portions may contribute to properly positioning the magnet in the housing.

In another of its aspects, the invention also provides a rotor for a rotary electric machine having permanent magnets and flux concentration, the rotor comprising:
a shaft extending along the axis of rotation of the rotor;
a rotor mass disposed on the shaft, and comprising:
   a central opening for mounting on the shaft; and
   housings in which the permanent magnets are placed, the housings being oriented radially, and each presenting a portion that is radially outside the corresponding permanent magnet, said portion presenting edges that converge towards each other on going away from the shaft.

The rotor may comprise at least one cavity in at least one, and preferably in each, angular interval between two consecutive housings.

The invention also provides an electric rotary machine such as a synchronous motor or a generator, and comprising a rotor as defined above. The machine may have a stator with concentrated or distributed windings.

In another of its aspects, the invention also provides a method of balancing a rotor as defined above, wherein the rotor is balanced by removing or adding material from or to at least one cavity, material possibly being added via holes formed in the resin in the cavities.

The material that is removed may for example be a synthetic material filling the cavity.

The invention can be better understood on reading the following detailed description of non-limiting embodiments thereof, and on examining the accompanying drawings, in which:

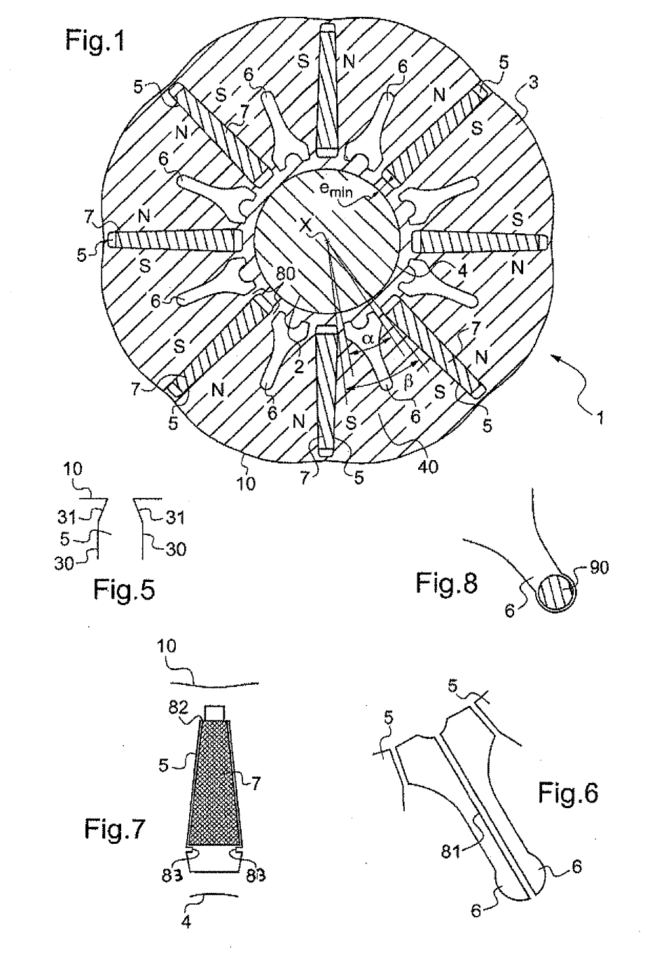

FIG. 1 is a diagrammatic cross-section view of an example of a rotor made in accordance with the invention;

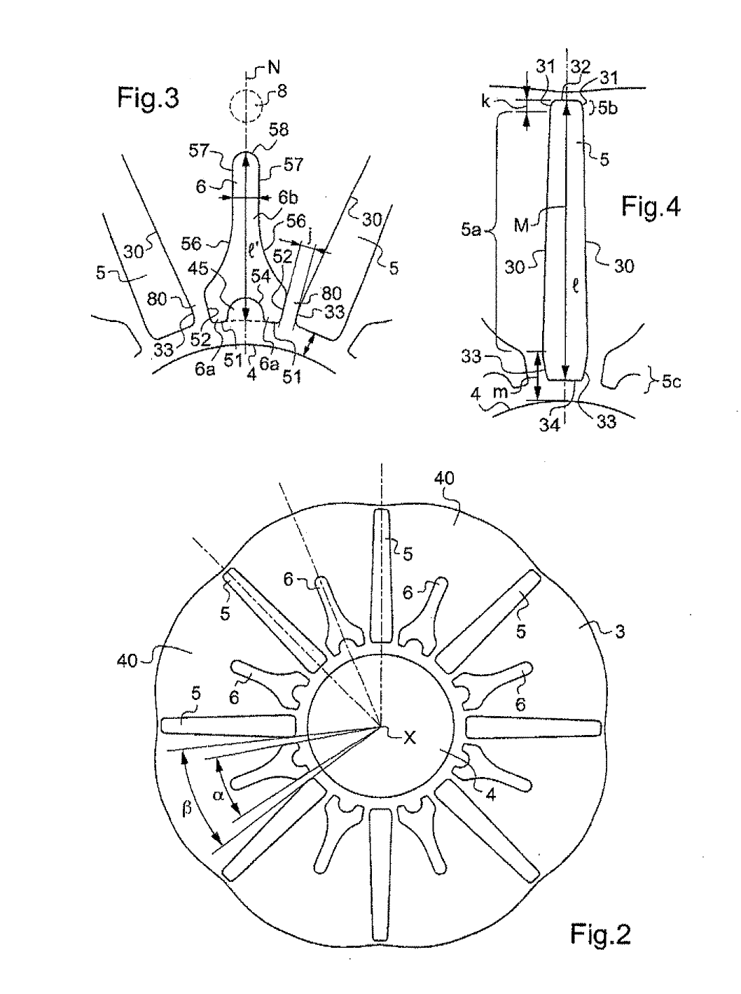

FIG. 2 shows the rotor mass in face view and on its own;

FIGS. 3 and 4 show embodiment details of the mass of FIG. 2; and

FIGS. 5 to 8 show variant embodiment details of the rotor.

The rotor 1 shown in FIG. 1 comprises a rotor magnetic mass 3 extending axially along the axis of rotation X of the rotor, the rotor mass being formed, for example, from a stack of laminations stacked along the axis X, the laminations being identical and exactly superposed, for example.

The rotor 1 has a plurality of permanent magnets 7 disposed in corresponding housings in the rotor magnetic mass, so that two consecutive magnets 7 present the same polarities on their facing faces.

The rotor mass 3 is mounted on a shaft 2 that, in the embodiment described, is made of magnetic material, e.g. steel.

The rotor mass 3 has a central opening 4 for receiving the shaft 2.

The rotor 1 is placed inside a stator (not shown) that includes a winding that may be concentrated or distributed, for example. The stator serves to generate a rotating magnetic field for driving the rotor in rotation, when used as a synchronous motor, and when used as an alternator, the rotation of the rotor induces an electromotive force (emf) in the coils of the stator.

The shape of the rotor mass 3 at its periphery may be multi-lobed as shown in FIG. 1, each lobe 10 extending between two consecutive magnets 7 and being outwardly convex.

In accordance with the invention, cavities 6 are located between the housings 5 and the magnets 7 to limit magnetic flux losses due to flux looping via the shaft 2 of the rotor.

Each housing 5 may present a radial dimension l greater than or equal to that of the corresponding magnet.

More particularly, each housing 5 may comprise a main portion 5a of radial dimension that corresponds to the radial dimension of the associated magnet 7, and end portions 5b and 5c located respectively radially outside and radially inside the magnet 7.

By way of example, the main portion 5a is of a shape that corresponds substantially to the cross sectional shape of the magnet 7.

In the example shown, the cross-section of the magnet 7 is trapezoidal and the housing 5 presents opposite edges 30 in its portion 5a that are rectilinear and that converge towards each other going away from the shaft 2.

The end portion 5b presents opposite edges 31 that may be rectilinear and that converge towards each other at a steeper angle than the edges 30.

The edges 31 may be connected together via an end edge 32 that, by way of example, is oriented perpendicularly to the midplane M of the housing 5, said midplane containing the axis of rotation X. In the example shown, the midplane M contains a radius, but the configuration could be otherwise.

The edges 31 need not be connected together and they may open to the outside of the rotor, as shown in FIG. 5. The magnet housings are then open to the outside of the rotor.

The end portion 5c is defined laterally by opposite edges 33 that converge towards each other going towards the shaft 2 and that are connected to an end edge 34 extending perpendicularly to the midplane M.

The angular extent of the interval 40 extending between two consecutive housings 7 is defined as being the angle β between the radii intersecting the edges of the housings 5 that are angularly the closest together, as can be seen in FIG. 1. In this example, it is the edges 33 that are angularly the closest together and these edges extend substantially radially.

Each interval 40 includes a cavity 6 that occupies an angular extent about the axis X that is relatively large, identified by the angle α in FIG. 1.

This angle α corresponds to the angle between radii passing via the edges of the cavity 6 that are angularly the furthest apart.

Preferably, there is no angular overlap between the housings and the cavities. In the example shown the angular difference between the housings and the cavities is equal to (β−α)/2, for example.

Each cavity 6 has two branches 6a that are united as a single branch 6b beyond an extension 45 on going away from the shaft 2.

The branches 6a are defined radially inwardly by edges 51 that are oriented circumferentially.

The branches 6a are defined laterally by opposite edges 52 each extending substantially parallel to the adjacent edge 33.

The extension 45 presents an edge 54 that is substantially semicircular.

The branch 6b is defined by opposite edges 56 that converge towards each other, e.g. in circular arcs. These edges 56 are connected on going away from the shaft 2 to opposite edges 57 that are rectilinear and parallel to the midplane M of the cavity 6, which midplane contains the axis of rotation X. The edges 57 are joined together by an edge 58 in the form of a circular arc.

Each rotor mass 3 has an annular portion of cylindrical shape that extends continuously around the axis of rotation X.

By way of example, the radial dimension eₘᵢₙ is at least 2 mm for a rotor having a diameter of 140 mm, however it could be much greater, or even smaller, depending on the centrifugal forces that need to be withstood and the size of the rotor.

The width j of the bridge of material 80 extending between a housing 5 and the adjacent cavity 6 may for example lie in the range 0.5 mm to 10 mm, e.g. being about 1.5 mm in the example described. The bridge of material 80 is at magnetic flux saturation, thereby limiting the passage of flux therethrough.

The radial dimension k of the portion 5b may lie in the range 2 mm to 3 mm, for example.

The junction between the edges 33 and 30 is at a distance m from the opening 4 that lies in the range 2 mm to 4 mm, for example.

A synthetic material may be injected into the housing 5 and/or the cavity 6 so as to block the magnets in the housings 5 and/or ensure cohesion of the stack of laminations if the rotor is constituted by an assembly of magnetic laminations. The material used may be an epoxy resin or a thermoplastic material, for example.

The magnets 7 may also be blocked by clamping under the action of centrifugal force, by virtue of being wedge-shaped.

The cavities 6 may be used for balancing purposes, e.g. by filling them with resin and then locally removing said resin or by making holes in the resin and filling them with resin or with one or more balance weights that fill the holes or that are merely fastened thereto.

Naturally, the invention is not limited to the embodiment described above.

For example, the laminations 3 may be made with holes 8, as shown in FIG. 3 for passing tie bars for assembling together the laminations of the stack.

It is possible to use magnets of a shape other than trapezoidal, in particular magnets that are rectangular or lozenge-shaped. The cavities may be given some other shape, and for example it is possible to provide two close-together cavities 16 in each interval between two consecutive housings, as shown in FIG. 6, or indeed to have only one cavity 6 for every two housings 5.

In FIG. 6, it can be seen that the two close-together cavities are separated by a central strip of material 81 that extends radially. The outline of these two close-together cavities may be generally similar to that of a single cavity 6 as described above with reference to FIG. 1.

Magnets may be held in the housings 5 by means of studs 83 as shown in FIG. 7, in particular adjacent to the rotor shaft.

In the presence of studs 83, the magnets may be held at the radially outer side of the rotor by a narrowing of the housing, this narrowing forming a shoulder 82 that extends substantially perpendicularly to the radius contained in the midplane of the housing 5, for example.

Assembly tie bars 90 may pass through the cavities 6, in particular through the radially outermost portions of the cavities for the purpose of assembling laminations together, as shown in FIG. 8.

The expression “comprising a” should be understood as being synonymous with “comprising at least one”.

1-26. (canceled)

27. A rotor for a rotary electric machine having permanent magnets and flux concentration, the rotor comprising:
a shaft extending along the axis of rotation of the rotor;
a rotor mass disposed on the shaft, the rotor mass comprising an assembly of rotor laminations each comprising a single piece, and comprising:
a central opening for mounting on the shaft; and
radially-oriented housings in which the permanent magnets are placed; and
at least one radially-oriented cavity in at least one angular interval between two consecutive housings, the cavity(ies) opening out neither to the central opening nor to the two consecutive housings, said cavity(ies) situated in said interval occupying an angular extent around the axis of rotation of the rotor that is greater than or equal to half the angular extent of said interval, the cavity(ies) creating zones between the permanent magnets that limit magnetic flux looping towards the radially inner portion of the rotor.

28. A rotor according to claim 27, the shaft being made of a magnetic material.

29. A rotor according to claim 27, the angular extent occupied by the cavity(ies) in said interval being greater than or equal to three-fourths of the angular extent of said interval.

30. A rotor according to claim 27, the cavities having a radial dimension less than or equal to the radial dimension of the housings.

31. A rotor according to claim 27, the housings having a radial dimension greater than or equal to the radial dimension of the corresponding permanent magnets.

32. A rotor according to claim 27, the housings opening radially outwards.

33. A rotor according to claim 27, the housings not opening radially outwards.

34. A rotor according to claim 27, the rotor mass comprising a single cavity for each interval between two consecutive housings.

35. A rotor according to claim 27, the rotor mass comprising a single cavity for two intervals between two consecutive housings.

36. A rotor according to claim 27, the radial dimension of the cavity(ies) being greater than the circumferential dimension thereof.

37. A rotor according to claim 27, the permanent magnets each presenting a non-rectangular shape in cross-section.

38. A rotor according to claim 37, each permanent magnet presenting a cross-section of trapezoidal shape.

39. A rotor according to claim 27, the housings and/or the cavities being filled at least partially with a synthetic material.

40. A rotor according to claim 27, each housing presenting a portion that is radially inside the corresponding permanent magnet and that is laterally defined by opposite edges that are radial.

41. A rotor according to claim 27, the rotor mass presenting a multi-lobed outer outline.

42. A rotor according to claim 27, each cavity having two branches beside the shaft, which branches are united going towards the stator.

43. A rotor according to claim 42, the two branches being separated by an extension having an edge that is concave towards the shaft.

44. A rotor according to claim 42, the branches having a radially inside edge) that is circumferentially oriented.

45. A rotor according to claim 42, each cavity having edges that converge towards each other from a distance from the axis of rotation that corresponds substantially to the radially inner ends of the magnets.

46. A rotor according to claim 45, the edges converging via circular arcs.

47. A rotor according to claim 45, said converging edges being extended by edges that are substantially parallel.

48. A rotor according to claim 27, each housing presenting a portion radially outside the permanent magnet, said portion having edges that converge towards each other going away from the shaft.

49. A rotor according to claim 27, the rotor including a plurality of cavities, the rotor mass comprising laminations and the rotor including tie bars for assembling said magnetic laminations together, the tie bars passing through the cavities.

50. A rotor for a rotary electric machine having permanent magnets and flux concentration, the rotor comprising:
a shaft extending along the axis of rotation of the rotor;
a rotor mass disposed on the shaft, the rotor mass comprising an assembly of rotor laminations each comprising a single piece, and comprising:
a central opening for mounting on the shaft; and
housings in which the permanent magnets are placed; and
at least one radially-oriented cavity in at least one angular interval between two consecutive housings, the cavity(ies) opening out neither to the central opening nor to the two consecutive housings, said cavity(ies) situated in said interval occupying an angular extent around the axis of rotation of the rotor that is greater than or equal to half the angular extent of said interval, each housing and the adjacent cavities being angularly offset without angular overlap.

51. A rotary electric machine including a rotor as defined in claim 27.

52. A method of balancing a rotor as defined in claim 27, wherein the rotor is balanced by adding or removing material to or from at least one cavity.
